(19) United States
(12) Patent Application Publication
(10) Pub. No.: US 2008/0072077 A1
(43) Pub. Date: Mar. 20, 2008

(54) Notification of Revocation in a Device Offering Secure Playback of Content

(75) Inventor: Stephen J. Orr, Markham (CA)

Correspondence Address: ADVANCED MICRO DEVICES, INC.;C/O VEDDER PRICE P.C., 222 N.LASALLE STREET, CHICAGO, IL, 60601, US

(73) Assignee: ATI TECHNOLOGIES INC., Markham (CA)

(21) Appl. No.: 11/466,992

(22) Filed: Aug. 24, 2006

(51) Int. Cl. G06F 12/14

(52) U.S. Cl. 713/194

(57) ABSTRACT

A device, suitable for playback of content, identifies components, installed on the device, to be used during playback of the content. Additionally, the device obtains a list of revoked components, which it compares with the identified device components. If one or more of the device components matches one or more entries in the list of revoked components, the identified revoked components are disabled such that they are prevented from playing back any pre-existing or future content. In a presently preferred embodiment, the device can automatically obtain an updated component corresponding to the revoked component and thereafter install the updated component so as to reinstate a secure environment. In this manner, user experiences regarding play back capabilities of devices may be improved and the overall security of the system is increased.

### FIELD OF THE INVENTION

The present invention relates generally to secure playback of content in device and, in particular, to techniques for notifying a device of revocation.

### BACKGROUND OF THE INVENTION

Digital rights management (DRM) systems and Content Protection (CP) systems are known in the art. In existing DRM/CP systems, access to content (i.e., published information suitable for consumption by a user) has an associated level of rights or restrictions and, based on the amount of content protection required, the playback system requests protection from all components to be used in its playback. In order for playback of content to occur, the playback system must trust all downstream components (relative to the source of the content) that contribute to the playback of the content. Typically, this trust is established by including a set of encryption keys in the downstream components. In older systems, like digital video disks (DVD) and related playback devices, these downstream keys have matching/partner keys embedded in the content itself. Successful matching of the relevant keys allows proper playback of the content. However, if any of the downstream components have been compromised (such as through compromise of an encryption key), the desired security is potentially lost. In response, a playback device can be revoked (i.e., preventing the device from playing back future content) by removing (from future content) those keys associated with the compromised device/component, thus preventing new content from working with the compromised playback system. However, the removal of compromised keys causes all playback devices that include the compromised keys to be revoked, regardless whether they were, in fact, compromised.

With newer DRM/CP solutions the concept of a “revocation list” allows the inclusion of a list of compromised playback components to be contained with the content. For example, the proposed Self-Protecting Digital Content (SPDC) scheme incorporates content protection and decoding software in the content itself. During playback, the content authenticates the downstream playback components and compares them with the revocation list to determine if content can be securely played back. If any component of the system is deemed to be compromised (revoked), the content does not play.

In both DRM/CP schemes described above, existing content being played on a compromised system continues to play in an insecure manner. In the latter scenario, if a downstream element is revoked, the newer content will not be played, but the downstream element that is deemed insecure will not be aware that it has been compromised. Furthermore, should a system (or portion thereof) become compromised, it is often possible through secure firmware and/or software driver updates to repair a compromised component and regain the trust in order to allow content playback to continue. In order for such repair to occur, however, the device and/or compromised components must first be made aware of the revocation.

What are needed therefore are techniques whereby a device can detect that it has been compromised and, as a result refuse to play all content (both newer and older) until such time as repairs are made to once again ensure security.

### BRIEF DESCRIPTION OF THE DRAWINGS

The features of the present invention are set forth with particularity in the appended claims. The invention itself, together with further features and attendant advantages, will become apparent from consideration of the following detailed description, taken in conjunction with the accompanying drawings. One or more embodiments of the present invention is now described by way of example only, with reference to the accompanying drawings wherein like referenced numerals represent like elements and in which:

FIG. 1 is a schematic block diagram of prior art systems for the playback of content by a device;

FIG. 2 is a schematic block diagram of systems for playback of content by a device in accordance with techniques employed by the present invention;

FIG. 3 is a schematic block diagram of an implementation of a device in accordance with the present invention;

FIG. 4 is a schematic block diagram illustrating an embodiment of a device in accordance with the present invention;

FIG. 5 is flowchart illustrating operation of a device in accordance with the present invention; and

FIG. 6 is a flowchart illustrating operation of content, having the capability to assess security of a playback device, in accordance with the present invention.

### DETAILED DESCRIPTION OF THE PRESENT EMBODIMENTS

Briefly, the present invention provides techniques for secure playback of content on devices and, where a compromised component or other insecure condition is detected, for notifying such devices of the existence of the insecure condition. Subsequent to receiving the notification, the device may undertake repair of the insecure condition, thereby restoring the capability of the device to play back the desired content. To this end, a device identifies components, installed on the device, capable of playing the content. Additionally, the device obtains a list of revoked components. Thereafter, the identified device components are compared with the list of revoked components and, if one or more of the device components matches one or more entries in the list of revoked components, the identified revoked components are disabled such that they are prevented from playing back any pre-existing or future content. In the presently preferred embodiment, the device can obtain an updated component corresponding to the revoked component and thereafter install the updated component so as to reinstate a secure environment. In this manner, user experiences regarding play back capabilities of devices may be improved. Further, by preventing the insecure playback of present and future content, the overall content protection provided by the device is increased.

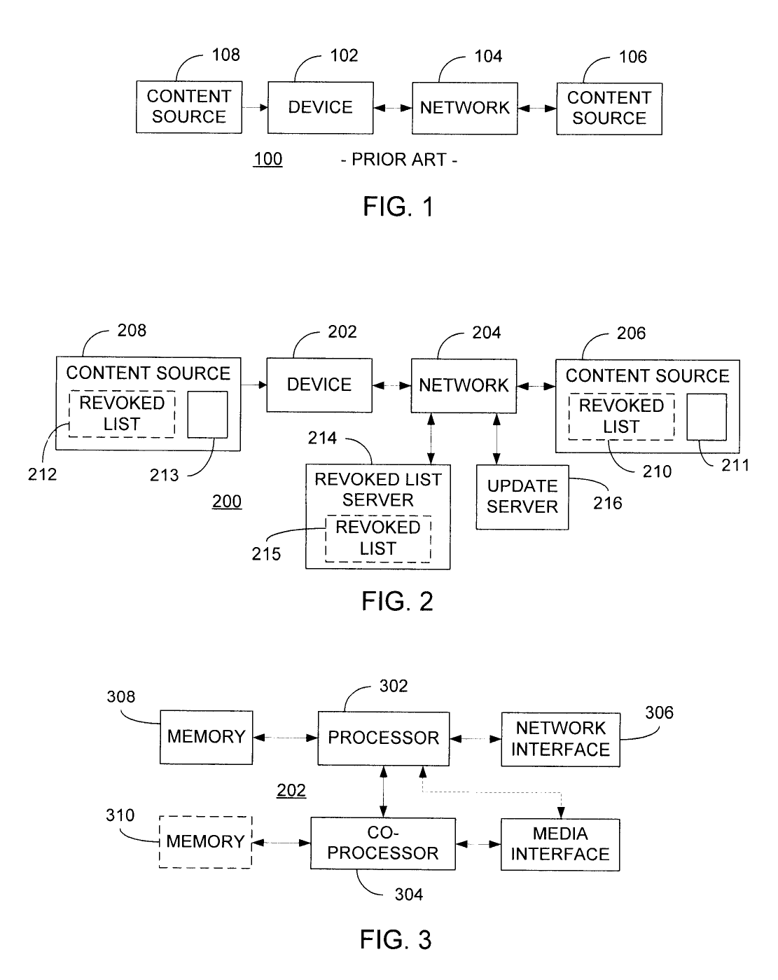

Referring now to FIG. 1, systems 100 in accordance with prior art techniques for the playback of content are illustrated. In particular, FIG. 1 illustrates a device 102 that may be coupled to content sources as illustrated. As used herein, a content source comprises any physical media (e.g., an optical, electrical or magnetic storage device, etc.) capable of storing content, preferably in digital form. As illustrated in FIG. 1 the device 102 may be directly coupled to a content source 108. For example, this may be the case where the device 102 comprises a DVD player and the content source 108 comprises a DVD. Alternatively, as shown, the device 102 may be in communication with a content source 106 via an intervening entity, such as network 104. For example, the network 104 may comprise a public or private communication network, such as the so-called World Wide Web or an entity's private intranet. In this instance, the content source 106 may comprise a suitably configured server, possibly implementing a website, as known in the art. In response to requests from the device 102, the server-based content source 106 provides content (e.g., in the form of streaming video or audio) to the device 102.

Regardless of the particular implementation used, the systems 100 illustrated in FIG. 1 suffer from the drawbacks described above. In particular, compromised security of the device 102, if detected, might result in the revocation of the device 102 such that future content might not be playable thereon. However, pre-existing content would nevertheless still be playable on the device 102. Of equal or greater significance, revocation of device 102 would likely result in the revocation of all other devices incorporating the same security mechanisms (i.e., encryption keys) thereby leading to unsatisfactory consumer experiences. Further still, no possibility exists for repairing the device 102 beyond, of course, total replacement.

As used in the context of the present invention, a component comprises anything, such as hardware elements, software elements or firmware elements, that assists in the rendering the content into a user-consumable form. For example, in the case of a compact disc (CD) player or similar device, a chain of components for playing the content may include a decompress/decode component, a digital mixer component and an output component. In a presently preferred embodiment, however, components are particularly limited to those elements that are updateable, e.g., software and firmware elements, as known in the art.

Referring now to FIG. 2, a system 200 in accordance with the present invention is further illustrated. In particular, the system 200, like the system 100 illustrated in FIG. 1, comprises a device 202 that is capable of communicating with a local content source 208 or with a remote content source 206 via, for example, an intervening network 204. Additionally, the system 200 includes a revoked list server 214 and, in a preferred embodiment, an update server 216. As described in further detail below, the revoked list server 214, which may comprise any of a number of computer-based network servers as known in the art, serves as a mechanism for providing a list of revoked components 215 to the device 202 via the network 204. Alternatively, either of the content sources 206, 208 may likewise act as a source of the list of the revoked components 210, 212. Techniques for assembling a list of revoked components are well known in the art. Additionally, in a preferred embodiment of the present invention, each of the content sources 206, 208 may also include stored instructions 211, 213 that allow the content sources 206, 208, via the device 202, to ascertain the security, or lack thereof, of the device 202. Content sources in accordance with this preferred embodiment, for example, may implement techniques described in the SPDC scheme described above.

In one aspect of the present invention, when the existence of a revoked component (or more generally, the existence of an insecure condition) is determined, it results in an indication of the revocation or insecure condition being provided to the device itself. Based on this indication, the device 202 can first disable any revoked components and, thereafter, seek to repair itself by installing an updated component corresponding to any revoked component. To this end, an update server 216 can act as a source for updated components. As in the case of the revoked list server 215, the update server 216 may comprise a network server as known in the art. Furthermore, techniques for providing updated components (such as, for example, downloadable software or firmware components) are well known in the art. It should also be noted that, although FIG. 2 illustrates the revoked list server 214 and the update server 216 as separate entities, in fact, they could be embodied in a single physical entity as known in the art.

Referring now to FIG. 3, an exemplary implementation of a device 202 in accordance with the present invention is shown. In particular, the device 202 comprises an application (or host) processor 302 in communication with memory 308. The processor 302 may comprise a microcontroller, microprocessor, digital signal processor, or combinations thereof, as known in the art. Likewise, the memory 308 may comprise volatile or non-volatile memory, such as random-access memory (RAM) or read-only memory (ROM) or other suitable storage devices used to store executable instructions that control operation of the processor 302. In a presently preferred embodiment, the memory 308 may comprise the physical media upon which content, to be played back by the device 202, resides. As shown, a network interface 306 is provided in communication with the processor 302. The network interface 306 supports communications between the device 202 and any suitable communication network. For example, where the network comprises a computer network, the interface 306 may support a number of well known computer network communication protocols, such as Ethernet, TCP/IP, etc. Alternatively, the interface 306 may support wireless network communication using circuitry and processing techniques well known to those having ordinary skill in the art.

The device 202 may comprise one or more co-processors 304, such as graphics or video co-processors, in communication with (or integrated with) the processor 302. Although not shown in FIG. 3, the co-processor(s) may share the memory 308 (again, which may include underlying content media) with the processor 302 and/or use local memory 310 accessible only to the co-processor(s). A media interface 312 is provided preferably in communication with the co-processor 304, although communication with the processor 302 is also possible as illustrated by the dotted line. The media interface 312 supports any mechanism suitable for interacting with any of a variety of physical media (CD-ROM, DVD, Blu-ray, HD-DVD discs, etc.) upon which content may be stored.

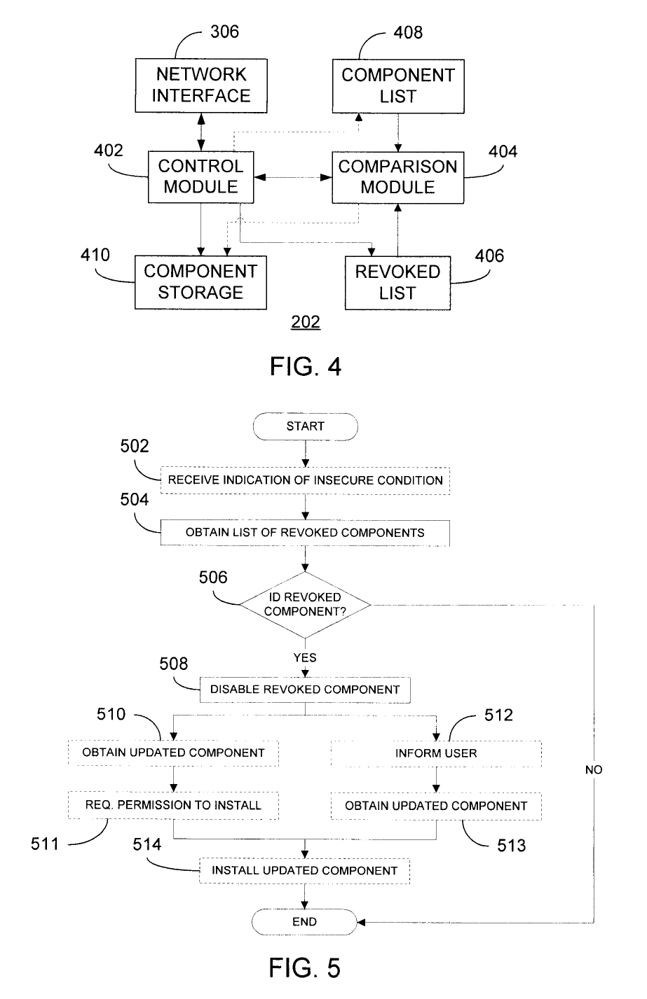

An embodiment of a device 202 in accordance with the present invention is illustrated in FIG. 4. In particular, the device 202 comprises a control module 402 in communication with a comparison module 404. In a presently preferred embodiment, the control module 402 and comparison module 404 are implemented using stored, executable instructions that are executed by a suitable processor. For example, either or both of the processor 302 or co-processor 304 shown in FIG. 3 may be used to implement the modules 402, 404. However, as known in the art, other techniques, such as application specific integrated circuits (ASIC), programmable logic arrays, etc. may be used to implement the modules 402, 404.

The control module 402 is operative to obtain a list of revoked components 406 and to identify device components 408 used during playback. As described above, the list of revoked components 406 may be obtained from a network (via the network interface 306) or directly from a content source (via the network interface 306 or media interface 312). Identification of the device components 408 used during playback may be accomplished through use of a pre-stored list of such components based on the configuration of the device 202 when initialized, or it may be periodically updated, for example, via the control module 402 as illustrated by the dotted line. For example, in a personal computer or similar device, the computer's system registry (or a subset thereof) may serve as the device component list. Other techniques for identifying device components used in playback, e.g., real-time polling rather than lists, may be equally employed. Regardless, when necessary, the control module 402 instructs or otherwise causes the comparison module 404, using well known techniques, to compare the list of revoked components 406 with the identified device components 408.

If any of the identified device components 408 matches a revoked component included in the list of revoked components 406, an indication of a revoked component can be provided to the control module 402. In this implementation, the control module 402 uses the indication received from the comparison module 404 to cause complete disablement of the identified component stored in component storage 410, which may comprise and suitable storage mechanism. Alternatively, the comparison module 404 may communicate directly with the component storage 410 for this same purpose, as illustrated by the dotted line.

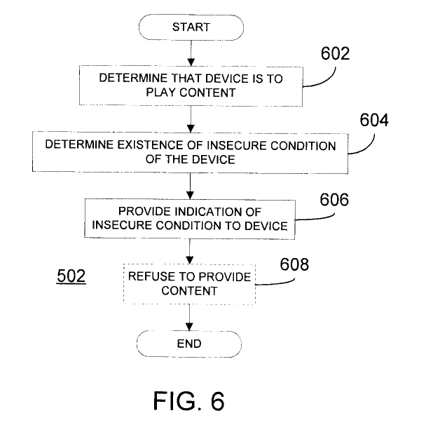

Referring now to FIG. 5, a flow chart illustrating operation of a device in accordance with the present invention is shown. The operations illustrated in FIG. 5 (and FIG. 6) are preferably carried out, unless noted otherwise, using a suitably programmed processor, as described above. However, it is understood that other means, such as programmable logic arrays, ASICs, etc. may be equally employed. Beginning at block 502, the device may optionally receive an indication of an insecure condition. In one embodiment of the present invention, described in further detail below, the source of the indication of insecure condition may comprise a content source. In this case, the device may carry out the remaining blocks illustrated in FIG. 5 in an attempt to verify the received indication of insecure condition. As used herein, an “insecure condition” indicates any set of operating circumstances that render a playback device incapable of secure playback at the level required by the current DRM/CP system.

Regardless, processing continues at block 504, where the device, preferably via an application processor or a graphics co-processor, obtains a list of revoked components and identifies device components to be used during playback as described above. Thereafter, at block 506, the identities of any revoked components are determined. If such revoked components are identified, processing continues at block 508 where the identified revoked component is disabled. In a presently preferred embodiment, this is accomplished by instructing the component to disable itself, as known in the art, such that it is incapable of playing back anything that requires content protection (CP). Alternatively, the revoked component could be “logically” removed from the device's system, e.g., removed from a registry of registered components. Still other techniques will be apparent to those of skill in the art.

Referring again to FIG. 5, blocks 510 through 514 illustrate optional operations that may be performed in order to remedy an insecure condition. Thus, at block 510 and in response to the identification of a revoked component, an updated component may be automatically obtained in accordance with the methods described above, i.e., via an update server. Other techniques for obtaining an updated component may be equally employed as a matter of design choice. After automatically obtaining the updated component, processing continues at block 511 where a user of the device is asked whether it is permissible to install the updated component, for example, using known processing techniques to initiate elicit an input response from the user. In an alternative embodiment, embodied by blocks 512 and 513, the device can first inform the user, at block 512, of the revoked component and the fact that it has been disabled. Thereafter, at block 513, the updated component is obtained (as described above) in response to an instruction from the user. Regardless of the manner in which it is obtained, processing continues at block 514 where the updated component is installed. Techniques for installing updated components, particularly firmware or software, are well known in the art. Additionally, where the revoked component is not readily updateable, as in the case of a hardware device, the processing of block 513 could be replaced by an operation in which the user obtains a new component and manually replaces the revoked component.

In a presently preferred embodiment, a portion of the processing illustrated in FIG. 5 is performed on a fully-automatic basis. In particular, it is desirable for the device to periodically obtain the list of revoked components (in a manner essentially identical to the capability of many computers to periodically and automatically check with an update server for any software updates) to identify revoked components installed on the device, if any, disable such components and thereafter automatically obtain and install the necessary updated component(s) without user intervention of any kind. Referring to FIG. 5, this is accomplished by the device automatically performing the processing described above relative to each of blocks 504-510 and 514. Proceeding in this manner, a user of the device is provided an even better experience to the extent that (s)he is not inconvenienced by a refusal to play content or a request to install an updated component.

Referring now to FIG. 6, a method for content to determine an insecure condition of a device in accordance with the present invention is illustrated. As noted above, content may include executable instructions that may be executed by the device. In this sense, the content is responsible for implementing the processing illustrated in FIG. 6. Beginning at block 602, the content first determines that a device is to be used to play the content. Thereafter, at block 604, the content can determine the existence of an insecure condition of the device. Assuming that an insecure condition is, in fact, detected, processing continues at block 606 where the content causes an indication of the insecure condition to be provided to the device. Once again, the indication provided at block 606 may serve as the indication described above relative to block 502 in FIG. 5. Regardless, in light of determining the existence of an insecure condition, the content can thereafter refuse to play back on the device as illustrated at block 608.

As described above, the present invention provides techniques for the secure playback of content and for the notification of devices that may include revoked playback components or otherwise experience an insecure condition. This is achieved, in one embodiment, by allowing the device to compare device components, used in during playback of the content, with a list of known revoked components. Revoked components identified in this manner may be completely disabled thereby prevent playback of any content, whether pre-existing or subsequent. Alternatively, the content itself can provide the indication of insecure condition to the device. Regardless, upon receiving the indication of insecure condition, the device can thereafter seek out and install an updated component, thereby restoring the playback capabilities of the device. For at least these reasons, the present invention represents an advancement over prior art techniques.

It is therefore contemplated that the present invention cover any and all modifications, variations or equivalents that fall within the spirit and scope of the basic underlying principles disclosed above and claimed herein.

What is claimed is:

1. In a system comprising a device capable of playing content from a source, a method for ensuring secure playback of the content, the method comprising:
identifying device components, installed on the device, to be used to play the content to provide identified components;
obtaining a list of revoked components;
identifying a component that has been revoked based on the identified components and the list of revoked components to provide a revoked component; and
disabling the revoked component.

2. The method of claim 1, wherein obtaining the list of revoked components further comprises the device obtaining the list of revoked components from a server via a network.

3. The method of claim 2, wherein obtaining a list of revoked components further comprises the device periodically requesting the list of revoked components from the server.

4. The method of claim 1, further comprising:
obtaining, by the device, an updated component corresponding to the revoked component; and
installing the updated component on the device.

5. The method of claim 4, wherein obtaining the updated component further comprises the device obtaining the updated component from a server via a network.

6. The method of claim 4, further comprising:
informing a user of the device that the revoked component has been disabled.

7. The method of claim 6, further comprising:
requesting permission from the user to install the updated component.

8. The method of claim 1, wherein disabling the revoked component further comprises instructing the revoked component to disable itself.

9. The method of claim 1, wherein obtaining the list of revoked components further comprises obtaining the list of revoked components from the content.

10. The method of claim 1, further comprising, prior to obtaining the list of revoked components:
receiving, by the device from the source, an indication of an insecure condition of the device.

11. A method for a source of content, capable of verifying secure playback of the content by a device, to inform the device of an insecure condition, the method comprising:
determining that the device is to be used to play the content;
detecting existence of the insecure condition of the device; and
providing an indication of the insecure condition to the device.

12. The method of claim 1 further comprising:
refusing access to the content.

13. The method of claim 11, wherein detecting existence of the insecure condition further comprises comparing identification of at least one component installed on the device used to play the content with a list of revoked components.

14. The method of claim 11, wherein detecting existence of the insecure condition further comprises failing to establish a secure link with the device.

15. The method of claim 11, wherein the insecure condition comprises a revoked component for playing the content, and wherein providing the indication further comprises notifying the device of the revoked component.

16. A device for playing content from a source in a secure manner, comprising:
a control module operative to identify device components, installed on the device, used to play the content and a list of revoked components; and
a comparison module, in communication with the control module, operative to identify a component that has been revoked based on the identified device components and the list of revoked components to provide a revoked component and further operative to cause disablement of the revoked component.

17. The device of claim 16, further comprising:
a network interface, in communication with the control module and a network, capable of communicating with a first server via the network.

18. The device of claim 17, wherein the control module is operative to request the list of revoked components from the first server.

19. The device of claim 17, wherein the control module is operative to obtain, from a second server via the network, an updated component corresponding to the revoked component, and to install the updated component on the device.

20. The device of claim 16, wherein the control module is further operative to obtain the list of revoked components from the content.

21. The device of claim 16, wherein the control module is operative to receive, from the source, an indication of an insecure condition of the device, and to obtain the list of revoked components responsive to the indication of the insecure condition.
